(19) United States
(12) Patent Application Publication
(10) Pub. No.: US 2011/0082400 A1
(43) Pub. Date: Apr. 7, 2011

(54) MASSAGE MECHANISM WITH A MOVEABLE MASSAGE SET HAVING A BIASED MOVEMENT

(76) Inventor: Dong-Her Wu, PUYEN HSIANG (TW)

(21) Appl. No.: 12/575,452

(22) Filed: Oct. 7, 2009

(51) Int. Cl. A61H 7/00

(52) U.S. Cl. 601/99

(57) ABSTRACT

A massage mechanism with a moveable massage set having a biased movement is installable in a massage chair or a massage bed, a standard chair or a mattress, and so forth, which provides a massage to multiple massage areas. Each massage element is composed of two biased, separated and correspondingly symmetric swing arms and two massage wheels disposed on the same surface side of two ends of the swing arms; when massage set is turned on, the spindle drives the swing arm with a biased rotation so that the massage wheels simultaneously provide a massage effect to the insides and outsides of both legs.

### BACKGROUND OF THE INVENTION

1. Field of the Invention

The present invention relates to a massage mechanism with a moveable massage set having a biased movement, and more particularly to a massage mechanism which can massage multiple areas on the legs of a user.

2. Description of the Related Art

Modern living is causing more and more people to suffer from high stress. A massage is one of the more common relaxation methods, which can help induce relaxation and rest. In addition, after long periods of standing up, or walking, running, or bicycling exercises, a user's leg muscles suffer from fatigue. In order to reduce such muscular pain, massage mechanisms are very popular relaxation products.

As shown in FIG. 12, a typical massage mechanism for individual usage or for use in combination with a massage chair comprises a driver in a main body 50. The driver has a spindle extending to both sides of the main body 50, which drives two pairs of swing plates 51 and two pairs of massage wheels 52 thereon to rotate. The main body 50 has openings 53 correspondingly to each pair of swing plates 51 and massage wheels 52. In operation, both legs of a user enter the openings 53 so that the soles are placed on top of the massage wheels 52 and the lower legs are pinched between each pair of swing plates 51. Therefore, with the rotation of the massage wheels 52 and the swinging movement of swing plates 51, the massage mechanism can provide a massaging effect.

However, since the driver of the massage mechanism, the spindle, the swing plates 51 and the massage wheel 52 are all securely fixed, the massage mechanism can only provide massage effects to the soles and lower legs of the user.

Therefore, it is desirable to provide a massage mechanism with a moveable massage set having a biased movement to mitigate and/or obviate the aforementioned problems.

### SUMMARY OF THE INVENTION

An objective of the present invention is to provide a massage mechanism with a moveable massage set having a biased movement.

The massage mechanism with a moveable massage set having a biased movement comprises a main frame and a massage set. The main frame has an opened end for a user to place his or her legs, another opposing end and upward bent sides that form a stop edge and sliding tracks. The two sliding tracks respectively have an internal sliding strip, and each sliding strip is lower than the center of the sliding track. Two separated raised strips are placed along a center of the top surface of the main frame and form or define a groove between them. The massage set has a driver such as a motor with a speed reducer, and the driver has a spindle with two extending ends that have reduced cross-sections. A massage element is secured to each of the extending ends of the spindle, and each massage element comprises two biased, separated and correspondingly symmetric swing arms and two massage wheels disposed on the same side face of two ends of the swing arms. The two pairs of massage wheels on the same end of the spindle face each other. A protrusion is disposed along the bottom of the driver. A roller and a bearing are combined in sequence and disposed at each of the two ends of the spindle, and the rollers, the bearings and the massage elements are all disposed on the reduced cross-sections of the spindle and driven by the spindle.

With the above-mentioned structure, the following benefits can be obtained: 1. the entire massage set can move back and forth in the limited space in the main frame and provide a massage effect to upper legs, lower legs and soles of the user; 2. each massage element is composed of two biased, separated and correspondingly symmetric swing arms and two massage wheels disposed on the same surface side of two ends of the swing arms; when massage set is turned on, the spindle drives the swing arm with a biased rotation so that the massage wheels simultaneously provide a massage effect to the insides and outsides of both legs.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the present invention.

FIG. 2 is an exploded view of the present invention.

FIG. 3 is a detailed view of a massage set according to the present invention.

FIG. 4 is a cross-sectional view of the present invention.

FIG. 5 shows movement of a swing arm according to the present invention.

FIG. 6 shows movement of a massage set arm according to the present invention.

FIG. 7 is a schematic drawing of a massage set moving downward according to the present invention.

FIG. 8 is a schematic drawing of a massage set moving upward according to the present invention.

FIG. 9 is a schematic drawing of a massage set moving upward and downward repeatedly according to the present invention.

FIG. 10 shows the present invention applied in a typical chair.

FIG. 11 shows the present invention applied in a typical mattress.

FIG. 12 is a perspective drawing of a prior art massage mechanism.

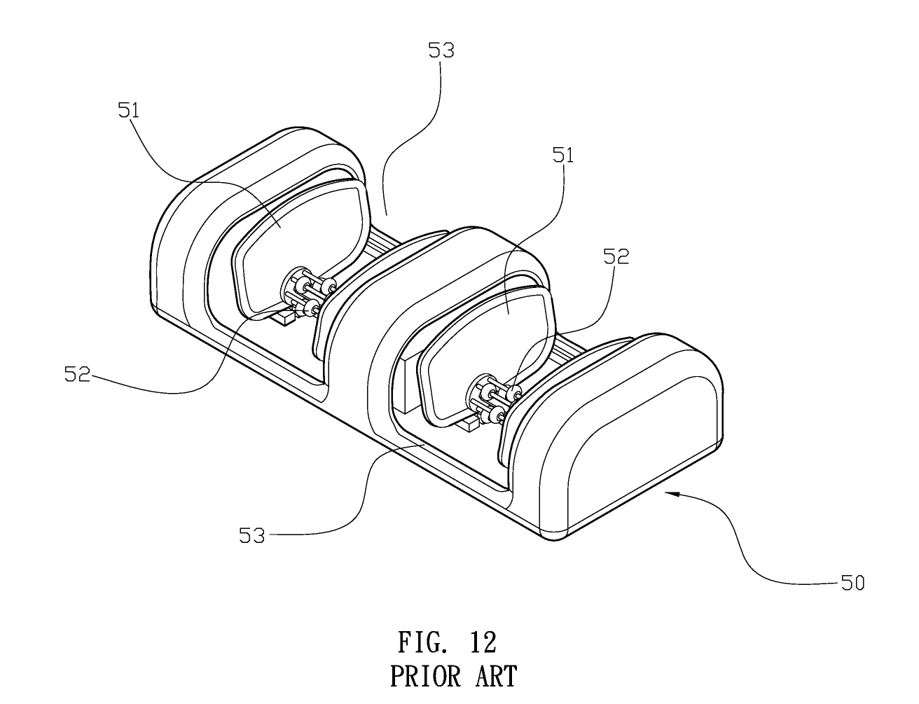

### DETAILED DESCRIPTION OF THE PREFERRED EMBODIMENT

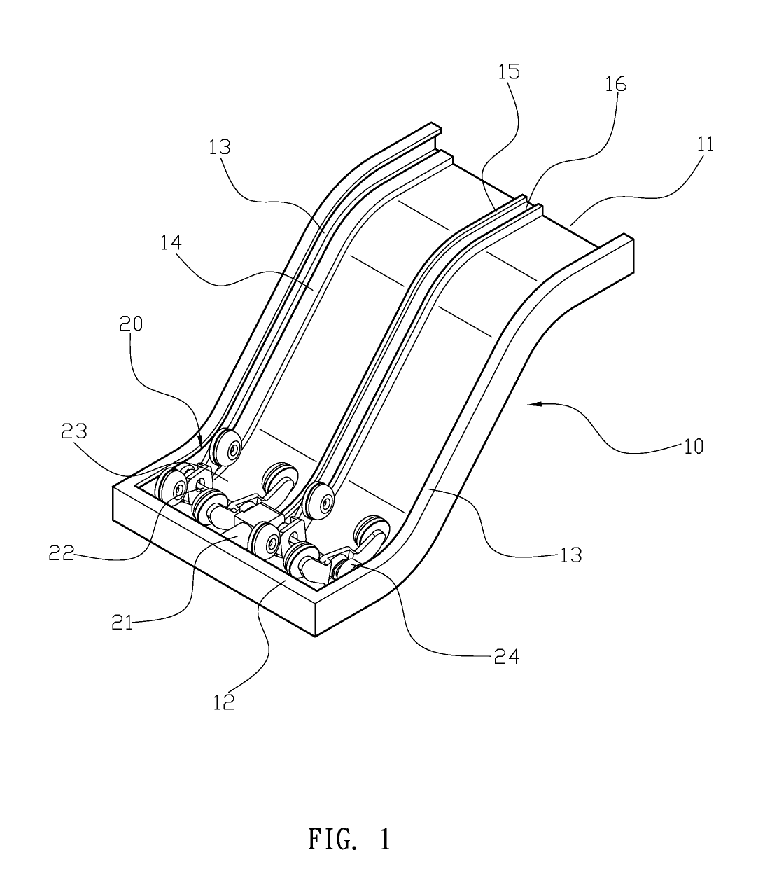

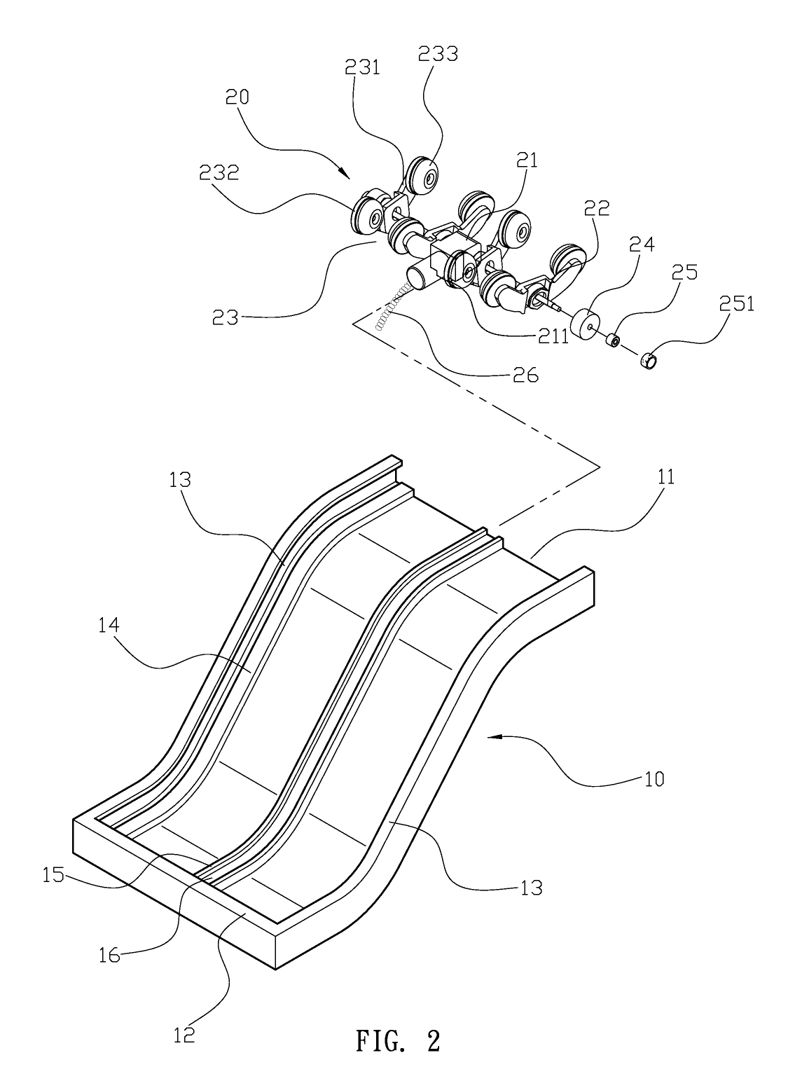

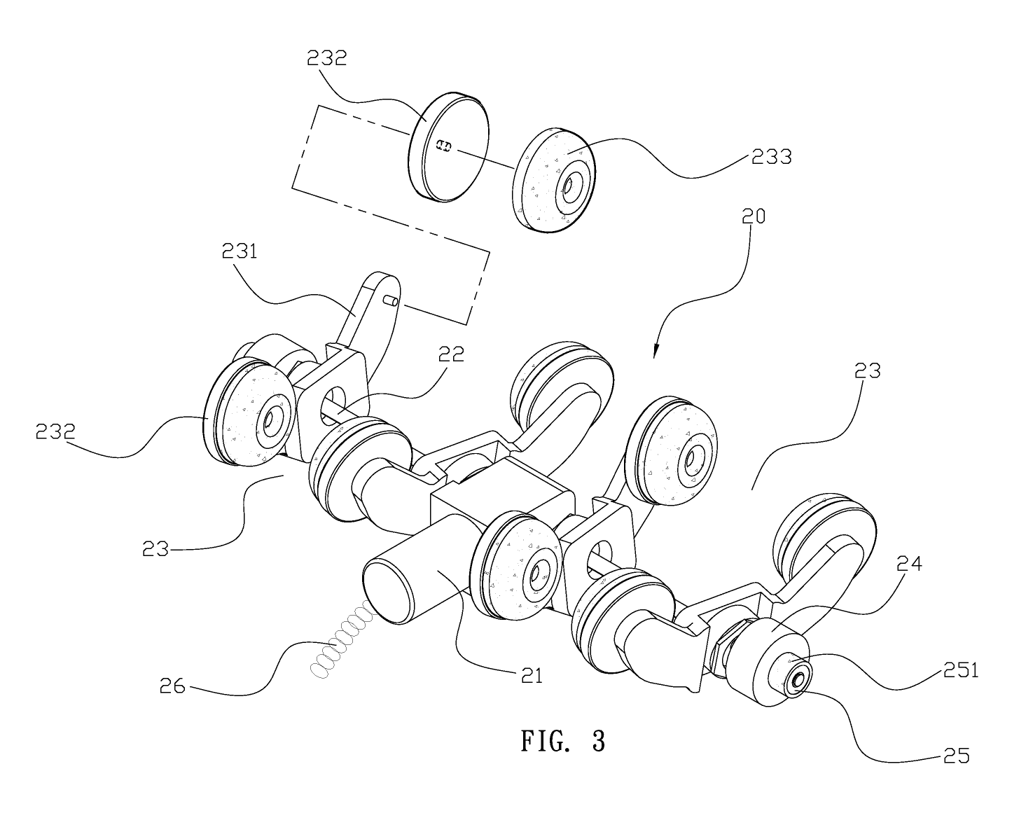

Please refer to FIG. 1, FIG. 2 and FIG. 3. A massage mechanism with a moveable massage set having a biased movement is installable in a massage chair or a massage bed, a standard chair or a mattress, and so forth, which provides a massage to multiple massage areas. The massage mechanism with a moveable massage set having a biased movement comprises a main frame 10 and a massage set 20. The main frame 10 has an opened end 11 for a user to place his or her legs, another opposing end and upward bent sides that form a stop edge 12 and sliding tracks 13. The two sliding tracks 13 respectively have an internal sliding strip 14, and each sliding strip 14 is lower than the center of the sliding track 13. Two separated raised strips 15 are placed along a center of the top surface of the main frame and form or define a groove 16 between them. The massage set 20 has a driver 21 such as a motor with a speed reducer, and the driver 21 has a spindle 22 with two extending ends that have reduced cross-sections. A massage element 23 is secured to each of the extending ends of the spindle 22, and each massage element 23 comprises two biased, separated and correspondingly symmetric swing arms 231 and two massage wheels 232 disposed on the same side face of two ends of the swing arms 231. The two pairs of massage wheels 232 on the same end of the spindle 22 face each other. A protrusion 211 is disposed along the bottom of the driver 21. A roller 24 and a bearing 25 are combined in sequence and disposed at each of the two ends of the spindle 22, and the rollers 24, the bearings 25 and the massage elements 23 are all disposed on the reduced cross-sections of the spindle 22 and driven by the spindle 22.

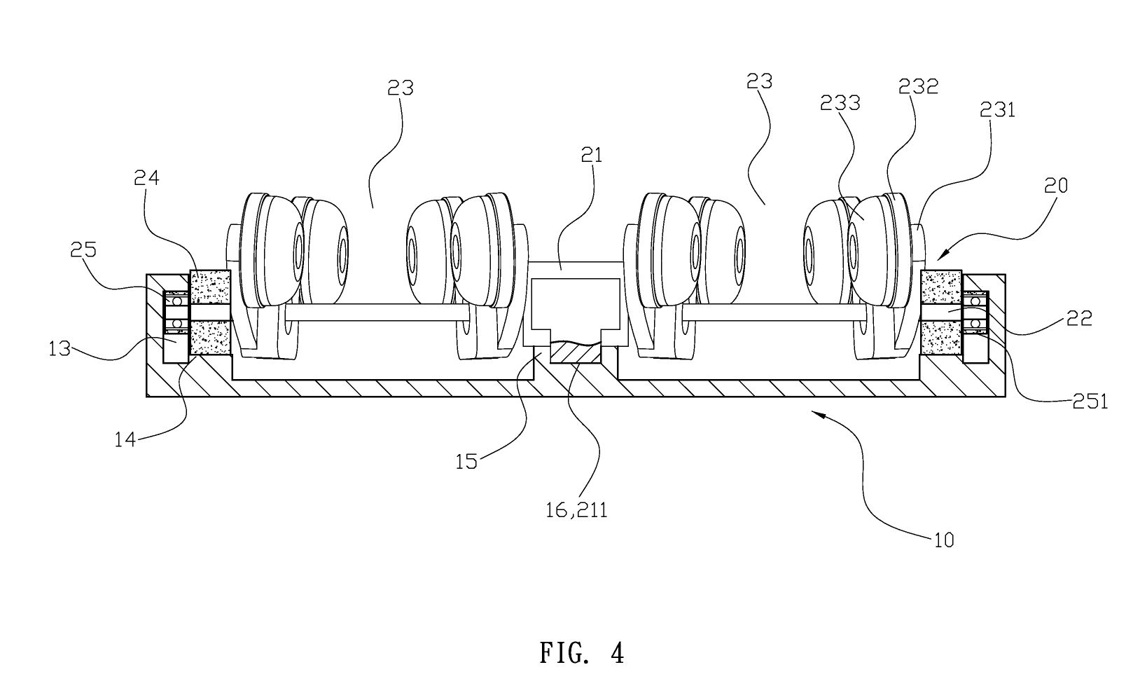

Please refer again to FIG. 1 and FIG. 4. The massage set 20 utilizes the protrusion 211 for engagement with the groove 16 of the main frame 10, the roller 24 pushes against the sliding strip 14, the bearing 25 slides along the sliding track 13 and the entire massage set 20 is installed from the opened end 11 of the main frame 10. When the massage set 20 is installed, the upper peripheral surface of the bearing 25 and the lower peripheral surface of the roller 24 are securely and tightly engaged with the top surface of the sliding track 13 and the sliding strip 14, such that a height difference in between generates a breaking effect. After the massage set 20 is installed, a power cable 26 of the driver 21 is connected to the main frame 10.

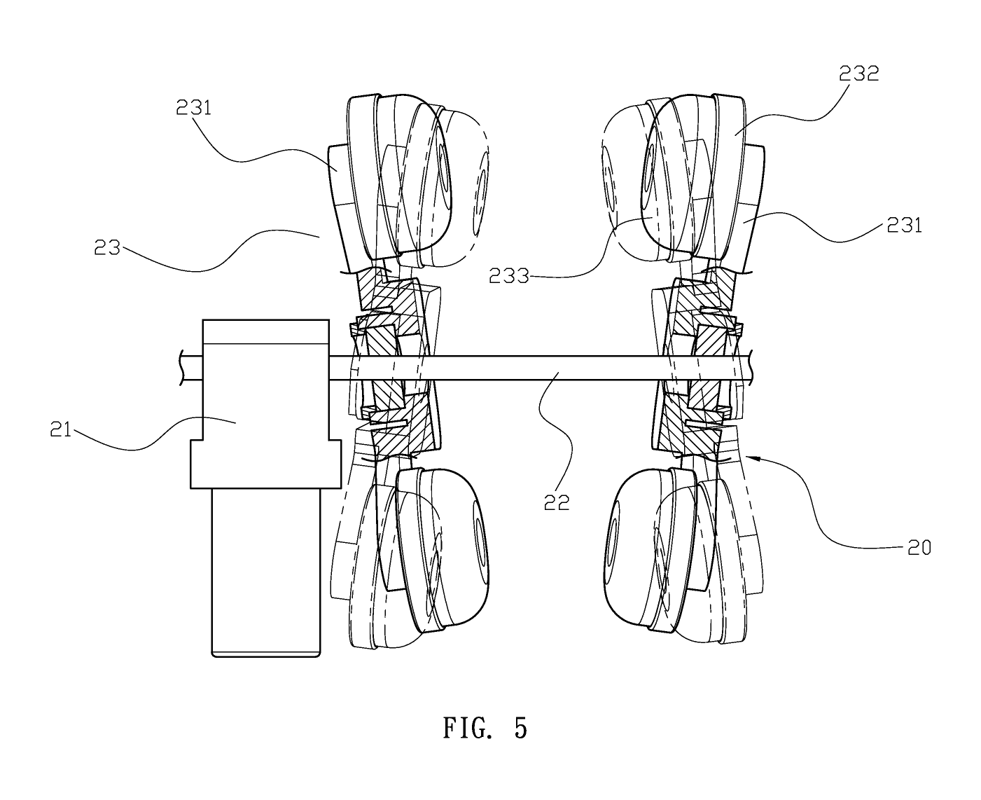

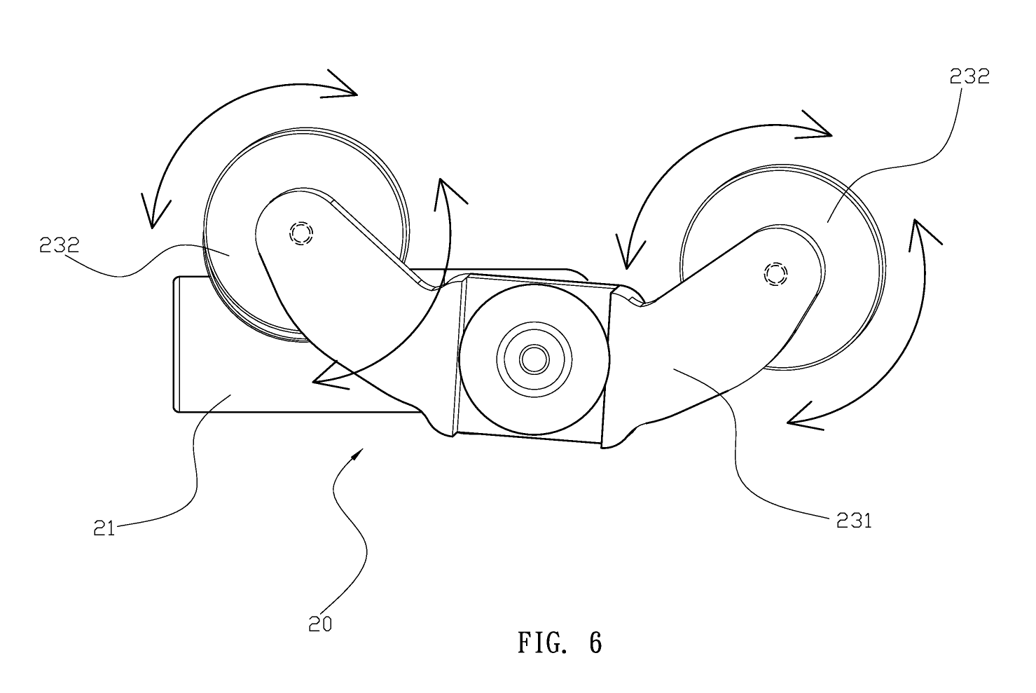

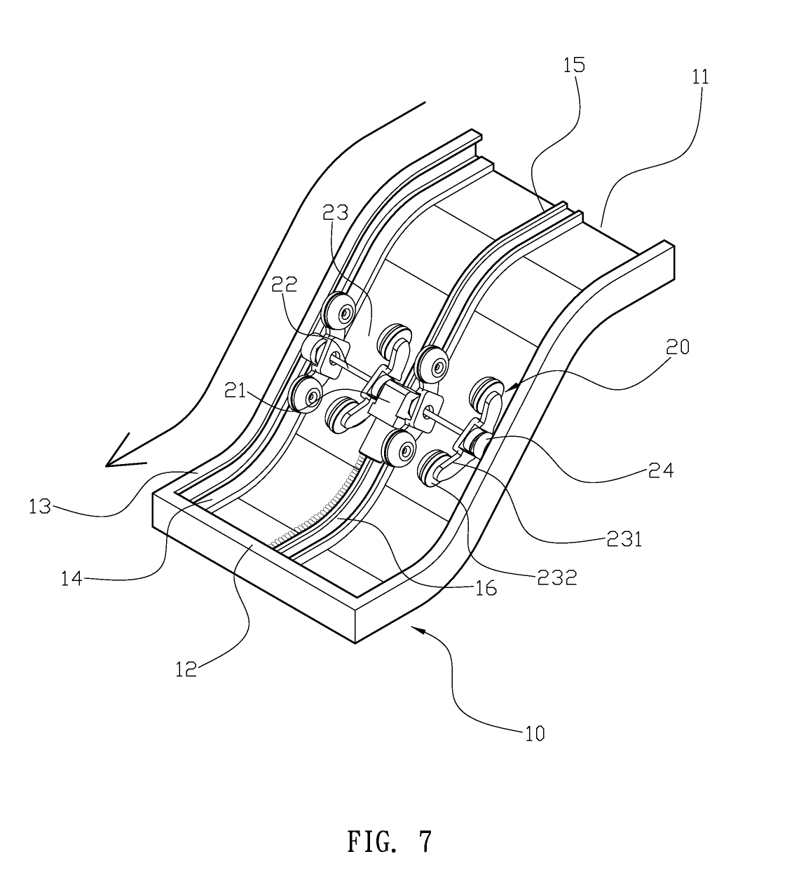

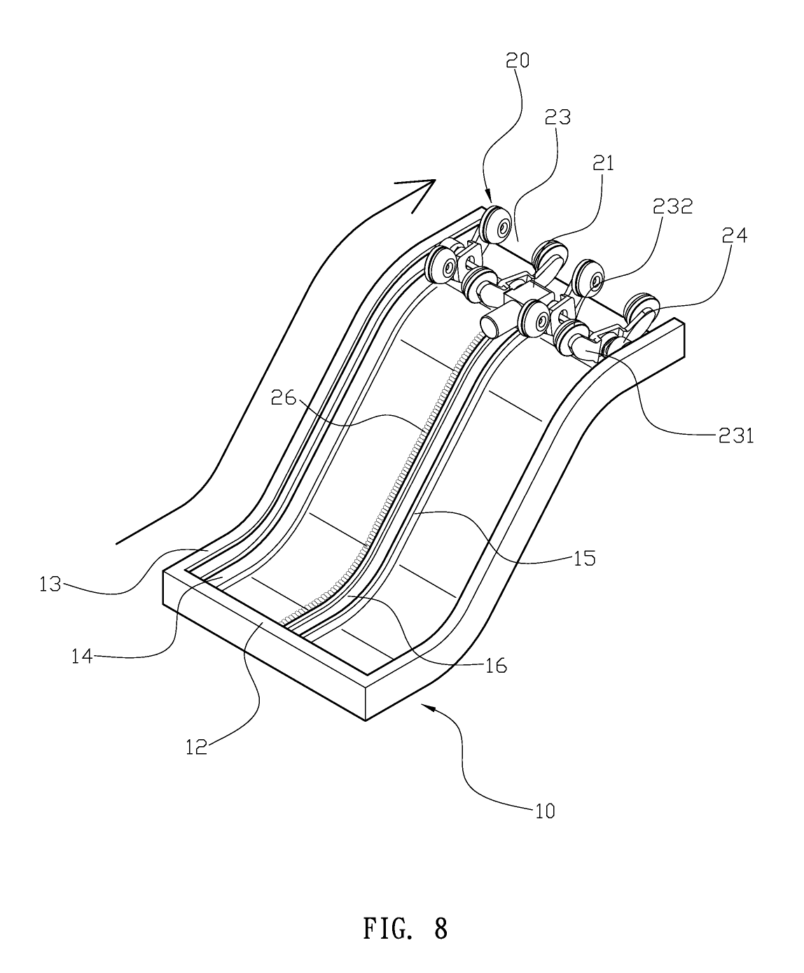

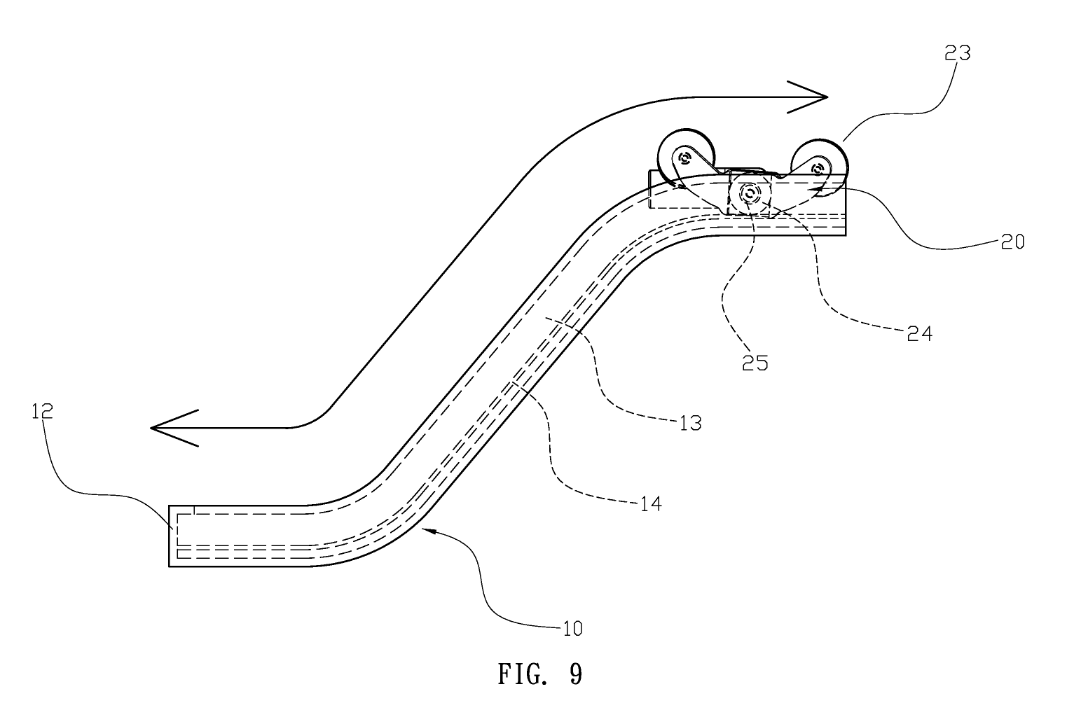

During actual operation, the use inserts both legs directly from the opened end 11 of the main frame 10 such that his or her upper legs, lower legs and soles all touch the smooth surface of the main frame 10. When the massage set 20 is turned on, the driver 21 utilizes the spindle 22 to drive the swing arm 231 in a biased rotation so the massage wheels 232 simultaneously provide a massage effect, as shown in FIG. 5 and FIG. 6, to the inside and outside of both legs. Furthermore, when the spindle 22 rotates, it also causes the roller 24 to spin; with the support provided by the bearing 25 touching against the top surface of the sliding track 13, the entire massage set 20 is able to move in the limited space in the main frame 10. The driver has a timer or a limiting switch triggerable when the massage set reaches a maximum distance to reverse movement of the massage set 20, as shown in FIG. 7, FIG. 8 and FIG. 9. Therefore, the massage mechanism is able to provide a massage effect to most parts of the legs.

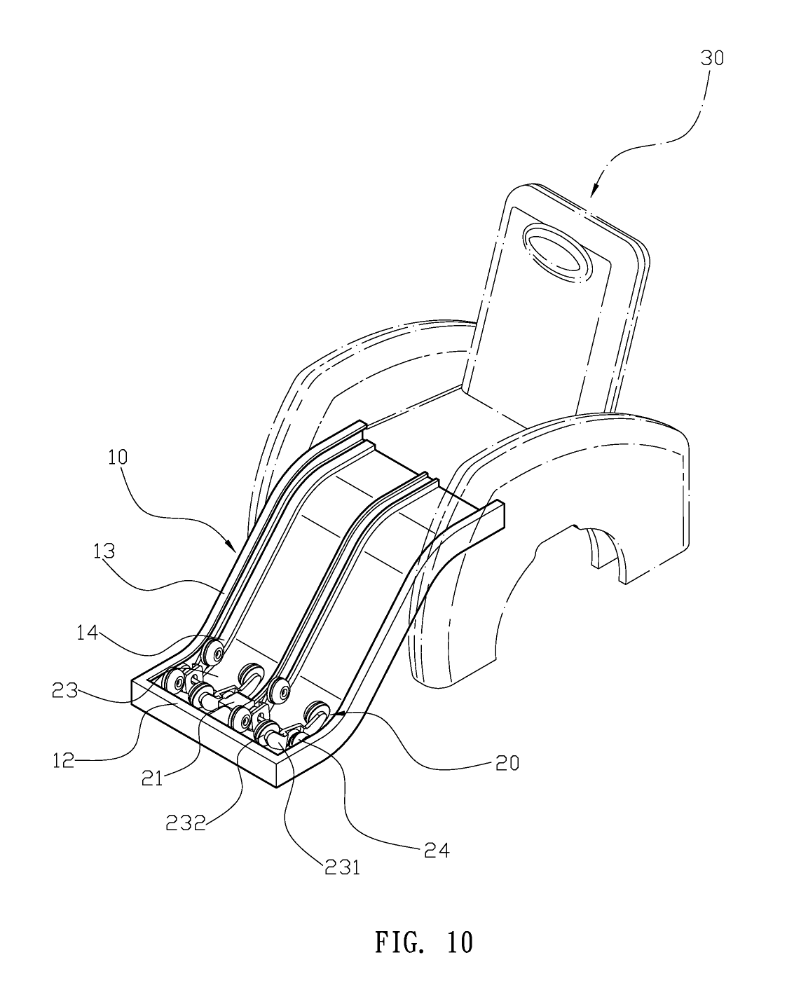

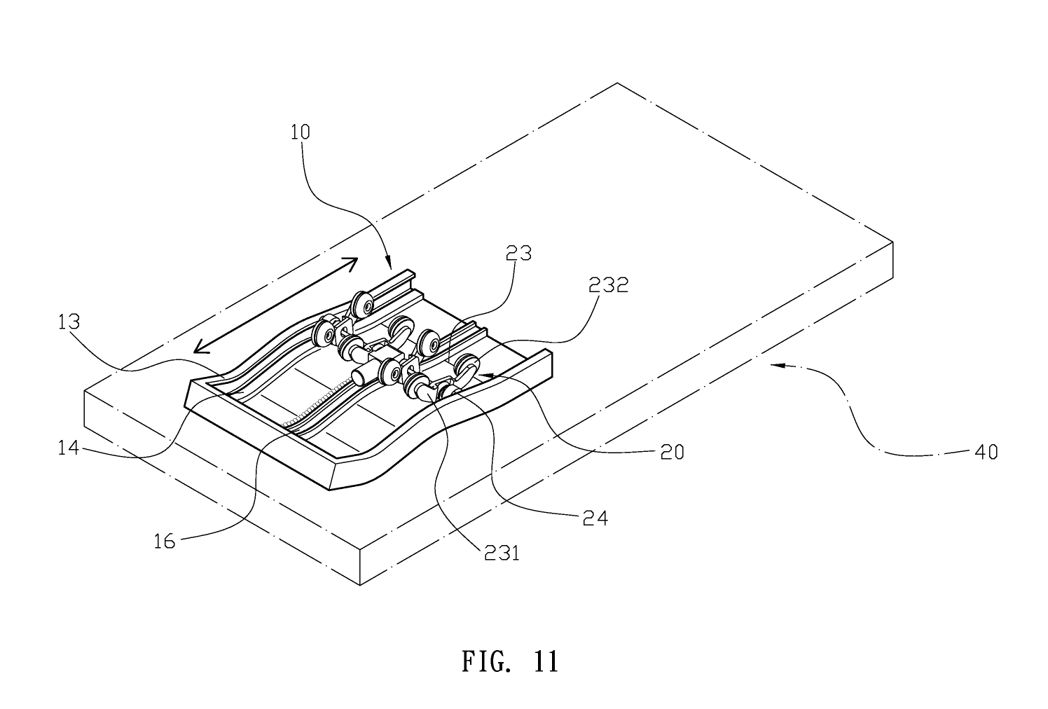

Moreover, the massage mechanism is suitable for use in a standard chair 30 or a mattress 40, as shown in FIG. 10 and FIG. 11, and so the user does not need to purchase an expensive massage chair or massage bed for the same enjoyment. The bearing 25 of the massage set 20 may be covered with a layer of rubber 251 which can prevent operational noise; and the massage wheels 232 may also be covered with a layer of soft material 233, such as foam or silicon, which provides a soft texture and prevents the massage wheel 232 from hurting the skin of the user.

With the above-mentioned structure, the following benefits can be obtained: 1. the entire massage set 20 can move back and forth in the limited space in the main frame 10 and provide a massage effect to upper legs, lower legs and soles of the user; 2. each massage element 23 is composed of two biased, separated and correspondingly symmetric swing arms 231 and two massage wheels 232 disposed on the same surface side of two ends of the swing arms 231; when massage set 20 is turned on, the spindle 22 drives the swing arm 231 with a biased rotation so that the massage wheels 232 simultaneously provide a massage effect to the insides and outsides of both legs.

Although the present invention has been explained in relation to its preferred embodiment, it is to be understood that many other possible modifications and variations can be made without departing from the spirit and scope of the invention as hereinafter claimed.

What is claimed is:

1. A massage mechanism with a moveable massage set having a biased movement comprising a main frame and a massage set, wherein:
the main frame has an opened end, another end and upward bent sides forming a stop edge and sliding tracks; the sliding tracks respectively having an internal sliding strip; each sliding strip being lower than the center of the sliding track; at least two separated raised strips along a center of the top surface of the main frame forming a groove;
the massage set having a driver, the driver having a spindle with two extending ends having reduced cross-sections; a massage element secured to each of the extending ends of the spindle; each massage element comprising biased, separated and correspondingly symmetric swing arms and massage wheels disposed on the same side of ends of the swing arms, the massage wheels on the same end of the spindle facing each other; a protrusion disposed on the bottom of the driver; a roller and a bearing combined in sequence and disposed on each of the two ends of the spindle; and the roller, the bearing and the massage element disposed on the reduced cross-section of the spindle and driven by the spindle;
wherein with the above-mentioned structure, the massage set utilizes the protrusion for engagement with the groove of the main frame, the roller pushes against on the sliding strip, the bearing slides along the sliding track and the entire massage set is installed from the opened end of the main frame; when the massage set is installed, an upper surface of the bearing and a lower surface of the roller are engaged with corresponding surfaces of the sliding track and the sliding strip, such that a height difference in between generates a breaking effect; a power cable of the driver connectable to the main frame; therefore, when the driver is activated, the spindle drives the massage element and the roller to rotate together during movement of the driver.

2. The massage mechanism with a moveable massage set having a biased movement as claimed in claim 1, wherein the massage mechanism is installable in a massage chair, a massage bed, a standard chair or a mattress.

3. The massage mechanism with moveable a massage set having a biased movement as claimed in claim 1, wherein the main frame has a curved shape matching a profile of the human leg.

4. The massage mechanism with a moveable massage set having a biased movement as claimed in claim 1, wherein the driver of the massage set includes a motor and a speed reducer.

5. The massage mechanism with a moveable massage set having a biased movement as claimed in claim 1, wherein the massage wheel is covered with a soft material.

6. The massage mechanism with a moveable massage set having a biased movement as claimed in claim 5, wherein the soft material is foam.

7. The massage mechanism with a moveable massage set having a biased movement as claimed in claim 5, wherein the soft material is silicon.

8. The massage mechanism with a moveable massage set having a biased movement as claimed in claim 1, wherein each pair of massage wheels is separately disposed on the front end and rear end of each swing arm.

9. The massage mechanism with a moveable massage set having a biased movement as claimed in claim 1, wherein the driver is controlled by a timer and operates in a reversed direction when the movement of the massage set reaches a maximum range.

10. The massage mechanism with a moveable massage set having a biased movement as claimed in claim 1, wherein the driver has a limiting switch triggerable when the massage set reaches a maximum distance to reverse movement of the massage set.

11. The massage mechanism with a moveable massage set having a biased movement as claimed in claim 1, wherein the bearing of the massage set is covered with rubber.
